(19) United States
(12) Patent Application Publication
(10) Pub. No.: US 2014/0324999 A1
(43) Pub. Date: Oct. 30, 2014

(54) APPARATUS AND METHOD FOR COMMUNICATION

(71) Applicant: Tencent Technology (Shenzhen) Company Limited, Shenzhen (CN)

(72) Inventors: Yi Dan, Shenzhen (CN); Yuewei Chen, Shenzhen (CN); Yu Mao, Shenzhen (CN); Yuan Zhao, Shenzhen (CN); Yiheng Liu, Shenzhen (CN)

(21) Appl. No.: 14/299,694

(22) Filed: Jun. 9, 2014

Related U.S. Application Data
(63) Continuation of application No. PCT/CN2014/070392, filed on Jan. 9, 2014.

(30) Foreign Application Priority Data
Apr. 28, 2013 (CN) 201310157327.5

(51) Int. Cl. H04L 12/58

(52) U.S. Cl. CPC H04L 51/22
USPC 709/206

(57) ABSTRACT

A method for acquiring unread messages receives a command for acquiring unread messages. In response, a priority values for each of the unread messages is determined. A threshold value for displaying the unread messages is determined. An unread message is acquired if the priority value of the unread message is larger than the threshold value. Also, disclosed is a device for performing the method for acquiring unread messages.

### CROSS REFERENCES TO RELATED APPLICATIONS

This application claims priority and is a continuation of PCT/CN2014/070392, filed on Jan. 9, 2014 and entitled “APPARATUS AND METHOD FOR COMMUNICATION”, which claims the benefit of Chinese Patent Application No. 201310157327.5, filed on Apr. 28, 2013 and entitled “APPARATUS AND METHOD FOR COMMUNICATION”, the contents of which are incorporated by reference in their entirety.

### FIELD

The present disclosure relates to the field of communications, in particular to a method and device for acquiring electronic mail messages.

### BACKGROUND

Today, electronic mail (email) is the preferred means of communication. It is common for an individual to have at least one email communication account. An individual typically receives electronic mail messages from several sources. Also, an individual may use a variety of devices to receive email messages.

### SUMMARY OF THE INVENTION

Disclosed in the embodiments of the present disclosure are a method and device for acquiring of unread messages, which can display the unread messages rapidly.

Provided in the embodiments of the present disclosure is a method for acquiring of unread messages, comprising receiving a command for acquiring unread messages; Determining the priority values of the unread messages; Determining a threshold value configured to position acquirable unread messages; Comparing the priority values with the threshold value; and Acquiring the unread message if the priority value of the unread message is larger than the threshold value.

Provided in the embodiments of the present disclosure is a device for acquiring of unread messages, comprising: a receiving unit, a first determining unit, a second determining unit, a comparing unit and an acquiring unit, wherein: The receiving unit is configured to receive a command for acquiring unread messages; The first determining unit is configured to determine the priority values of the unread messages; The second determining unit is configured to determine a threshold value configured to position acquirable unread messages; The comparing unit is configured to compare the priority values with the threshold value; and The acquiring unit is configured to acquire the unread message if the priority value of the unread message is larger than the threshold value.

In the aforementioned technical solution, a command for acquiring unread messages is received; the priority values of the unread messages are determined; a threshold value configured to position acquirable unread messages is determined; the priority values are compared with the threshold value; and the unread message is acquired if the priority value of the unread message is larger than the threshold value, in this way, the unread messages can be rapidly acquired only by reception of the command for acquiring unread messages.

### BRIEF DESCRIPTION OF THE DRAWINGS

FIG. 1 is a flow diagram of a method for acquiring unread messages provided in the embodiments of the present disclosure;

FIG. 2 is a flow diagram of another method for acquiring unread messages provided in the embodiments of the present disclosure;

FIG. 3 is a structural diagram of a device for acquiring unread messages provided in the embodiments of the present disclosure;

FIG. 4 is a structural diagram of another device for acquiring unread messages provided in the embodiments of the present disclosure;

### DETAILED DESCRIPTION

Apparatus described herein and methods implemented therein retrieve unread email messages received at a receiving communication account based on a priority value associated with each of the unread messages.

The priority value associated with an unread message may be determined based on metadata associated with the unread message. Metadata may include the reception time of the unread message, the sending time of the unread message, the identity of the sending communication account, the size of the unread message etc. In other instances, the priority of an unread message may be determined based on the prior communication history between the sending and receiving communication accounts.

The priority value determined for each unread message may be compared with a threshold value. If the priority value exceeds the threshold, the unread message corresponding to the unread message may be retrieved.

As used herein a receiving and sending communication account may be an instant messaging account, a mobile phone number, an email account and the like. Typically a user logs into a server to receive and send email messages or simply messages. A user may use a remote terminal to log into the server. The remote terminal and server communicatively coupled via a network. The server is configured to identify or validate the identity of the user based on the user's login credentials. After the identity user is validated, the server may acquire unread messages from the user's communication account and communicate them to the remote terminal where the user may read the unread messages. The unread messages may be received from other sending communication accounts.

In one scenario, a set of unread messages may be available at the receiving communication account. Each of the set of unread messages may be associated with metadata. In an embodiment, methods described herein may compute a respective first priority value for each unread messages in the set based on a first information in the metadata associated with the corresponding unread message. As previously discussed the first information may correspond to the reception time, for example, of the unread message. The priority of each unread message in the set may be compared with a threshold. Unread messages with respective priority values that exceed the threshold may be acquired. The acquired unread messages may be referred to as a first subset of unread messages.

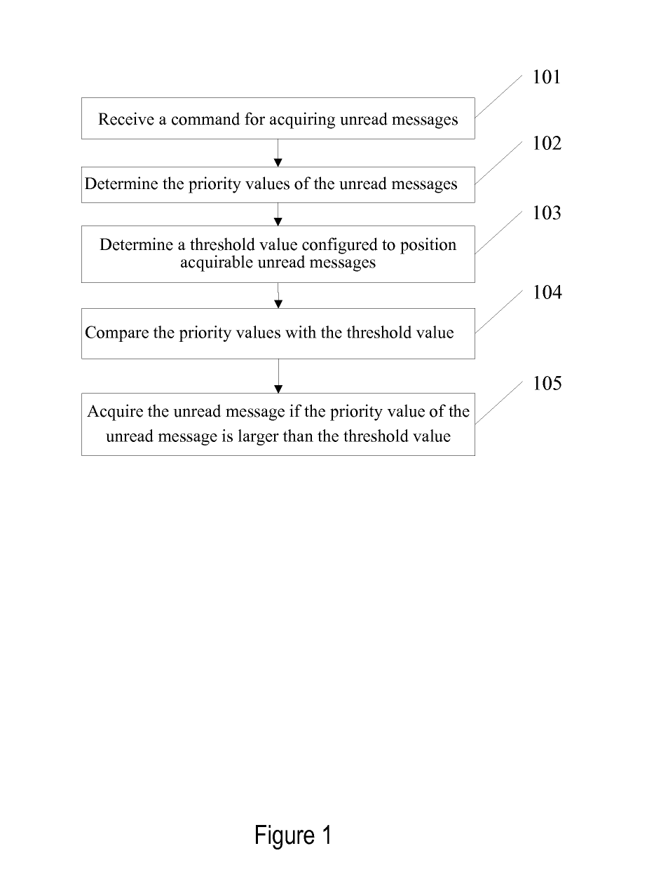

FIG. 1 is a flow diagram of an example method for acquiring unread messages. The method may be implemented at an email server, in an embodiment.

At block 101, a command for acquiring unread messages may be received. The command may be received in response to a user clicking or double clicking a user interface button at a terminal. The terminal may be a personal computer (PC), a tablet computer, a mobile phone, a smart phone, a notebook computer or other equipment. In an embodiment, as previously discussed the user may have previously logged into a receiving communication account using login information associated with the user and the receiving communication account.

At block 102 the priority value for each of the unread messages is determined. In an embodiment, the priority values of an unread message may be determined based on the reception time of the unread messages at the receiving communication account. That is, the priority value of the unread messages is in proportion to the reception time of the unread message. For example an earlier reception time of an unread message means higher priority value of the unread message and a later reception time means a lower priority value.

In another embodiment, the priority value of an unread message may be based on a relationship between the sending communication account associated with the unread message and the receiving communication account. The relationship may be defined as a friend level between the user of receiving communication account and the user of the sending communication account. In an embodiment, the friend level may be calculated based on the number of unread messages at the receiving communication account that are associated with the sending communication account. The higher the number of read messages from a sending communication account in the receiving communication account, the higher the friend level. In an embodiment, the higher the number of read messages associated with sending communication account, the higher the priority assigned to an unread message received from the sending communication account. Conversely, a lower priority is assigned to an unread message if a high number of messages received from the sending communication account remain unread.

At block 103 a threshold value is determined. The priority values of the unread messages can be compared with the threshold value and unread messages whose priority exceeds the threshold may be acquired, in an embodiment.

In an embodiment, the threshold value may correspond to a preset fixed value. In this embodiment; only unread whose priority exceeds the preset threshold may be acquired. In another embodiment, the preset threshold value may correspond to a lower bound on the priority. For example, the unread messages may be sorted or arranged by their respective priority and only a preset number of the arranged unread messages may be acquired. The preset number may correspond to the threshold value, in an embodiment. For example only unread messages which rank at the top three in a descending order may be acquired.

In another embodiment, a threshold value may be determined based on the number of unread messages at the receiving communication account. In an embodiment, the threshold value is in direct proportion to the number of unread messages at the receiving communication account. For example, the greater the number of unread messages at the receiving communication account, the larger the threshold value is set to. In this embodiment the threshold value is calculated in real-time, and varies with the number of unread messages at the receiving communication account, for example, the threshold value may be set as 10 if the number of unread messages at the receiving communication account is 100, and may be set as 4 if the number of unread messages at the receiving communication account is 20.

At block 104 the priority value associated with each of the unread messages is compared with the threshold value determined at block 103. This comparison may be a value comparison, in order to subsequently acquire the unread messages.

At block 105 an unread message may be acquired if the priority value of the unread message is larger than the threshold value.

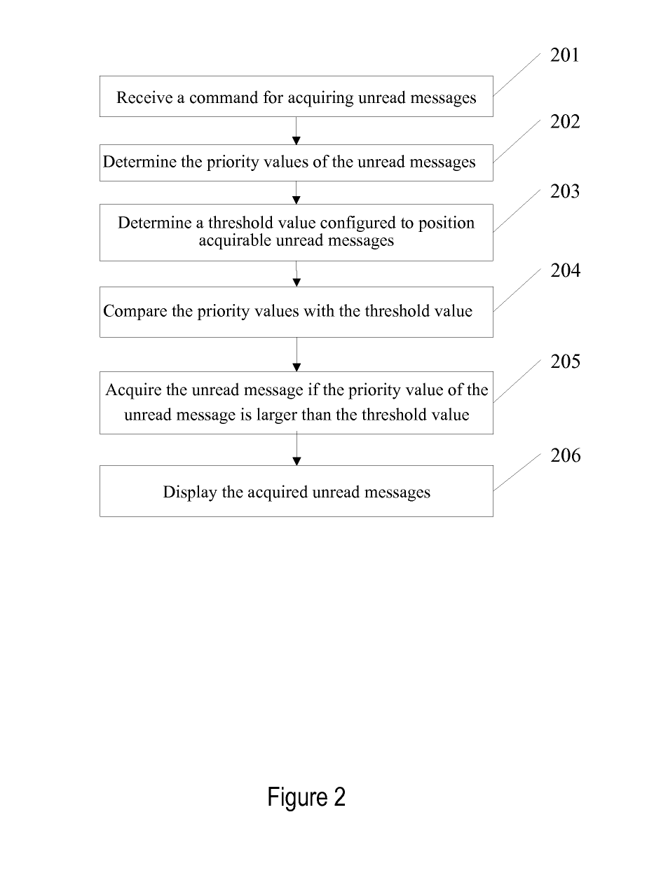

FIG. 2 is a flow diagram of another method for acquiring of unread messages provided in the embodiments of the present disclosure. At block 201, a command for acquiring unread messages may be received. The command may be received in response to a user clicking or double clicking a user interface button at a terminal. The terminal may be a personal computer (PC), a tablet computer, a mobile phone, a smart phone, a notebook computer or other equipment. In an embodiment, the user may have logged into a receiving communication account using login information associated with the user and the receiving communication account.

At block 202 the priority value for each of the unread messages is determined. In an embodiment, the priority values of an unread message may be determined based on the reception time of the unread messages at the receiving communication account. That is, the priority value of the unread messages is in proportion to the reception time of the unread message. For example an earlier reception time of an unread message means higher priority value of the unread message and a later reception time means a lower priority value.

For example, if there are 10 unread messages at the receiving communication account, where, these 10 unread messages have a reception time sequence corresponding to unread message 1, unread message 2, unread message 3 . . . unread message 10, in an embodiment at step 202, the priority value of the unread message 1 is set to be the highest, followed by the unread message 2 and then the unread message 3. In another embodiment, at step 202: the priority value of the unread message 10 is set to be the highest, followed by the unread message 9 and then the rest unread messages.

In another embodiment, the priority value of an unread message may be based on a relationship between the sending communication account associated with the unread message and the receiving communication account. The relationship may be defined as a friend level between the user of receiving communication account and the user of the sending communication account. In an embodiment, the friend level may be calculated based on the number of unread messages at the receiving communication account that are associated with the sending communication account. The higher the number of read messages from a sending communication account in the receiving communication account, the higher the friend level. In an embodiment, the higher the number of read messages associated with sending communication account, the higher the priority assigned to an unread message received from the sending communication account. Conversely, a lower priority is assigned to an unread message if a high number of messages received from the sending communication account remain unread.

In another embodiment a friend level for a sending communication account may be calculated according to stored communication records between the sending communication accounts and the receiving communication account. For example, the communication records may be communication records that are pre-recorded and stored, and may also be communication records of the read messages between the sending communication account and the receiving communication account. In an embodiment, the method is configured to record the number of messages sent by the sending communication account to the receiving communication account that have been read. In this embodiment, an unread message received from a sending communication account with a higher number of recorded previously read messages is assigned a higher priority. In another embodiment, the method is configured to record the number of unread messages sent by the sending communication account to the receiving communication account. In still another embodiment, the method is configured to generate communication records of the read and unread messages between the sending communication account and the receiving communication account.

In an embodiment, the display area of the user interface at which the unread messages are to be displayed may be received when the user logs in. In this embodiment, the priority of an unread message may be determined based on the size of the unread message to be displayed. For example, if an unread message has a size that is greater than the display area of the user interface, the unread message may be assigned a lower priority than an unread message that has size that is less than the display area of the user interface.

At block 203 a threshold value to for the number of unread messages to be acquired may be determined. At block 204 the priority values for each unread message may be compared with the threshold value. At block 205 an unread message may be acquired if the priority value of the unread message is larger than the threshold value.

At block 206 the acquired unread message may be formatted to be displayed at the user interface of the user device that requested the unread messages.

In another embodiment, the method of FIG. 2 may be implemented to acquire unread messages in a multilevel way. In this embodiment, a first priority value and a second priority value may be determined for each unread messages. The first priority value of an unread message may be compared with a first threshold. In this embodiment at step 205, if the first priority value of the unread message is larger than the first threshold value, the unread message is selected. If the displaying area required for displaying the first unread messages is larger than the area of the interface configured to display the unread messages, this embodiment may further comprise, acquiring a second unread message using the second priority value which is larger than the second threshold value. If the display area for displaying the acquired second unread messages is smaller than the area of the interface configured to display the unread messages, the aforementioned second unread messages can be displayed at step 206.

The first priority of the message may be determined using any one of the previously described methods. For example, the first priority of an unread message may correspond to the reception time at the receiving communication account; that is, the first priority values are calculated according to the reception time of the unread messages. The second priority value of the unread messages may correspond to the friend level of the sending communication account associated with the first communication account.

In another embodiment, the first priority value of an unread message may be determined based on the friend level of the sending communication account of the unread messages of the first communication account. The second priority value of the unread message may be determined based on the reception time of the unread messages of the first communication account.

In another embodiment, the first or second priority of an unread message may correspond to the relationship between the displaying area required for displaying the unread message and the area of the interface configured to display the unread messages, in the step 206.

In yet another embodiment, a first subset of unread messages with first priority values that exceed a first threshold may be selected from a set of unread messages. A second subset of unread messages with second priority values that exceed a second threshold may be selected from the first subset. The second subset of unread messages may be acquired and displayed.

By way of example and without limitation, the first subset of unread messages may be selected based on the respective reception time of the unread messages. In one scenario, the first threshold may be selected as the last 24 hours. In this scenario, messages received within the last 24 hours will be selected as the first subset. Next, a second priority value may be determined for each of the first subset of unread messages. The second priority value may correspond to the friend value associated with the respective sending communication account associated with each of the unread messages in the first subset. Unread messages in the first subset with friend level which exceed a second threshold may then be acquired. In this scenario, only unread messages with friend level exceeding a threshold received in the last 24 hours will be acquired.

In the aforementioned technical solution, a plurality of alternative embodiments are described on the basis of the embodiments hereinabove, and the unread messages can be displayed rapidly according to the priority values of the unread messages.

Described below are the embodiments of the device in the present disclosure, which are configured to execute the method implemented in the embodiments 1 and 2 of the method in the present disclosure; for easiness in description, only the parts relevant to the embodiments of the present disclosure are illustrated, and with regard to specific technical details that have not been disclosed, reference shall be made to the embodiment 1 and the embodiment 2 of the present disclosure.

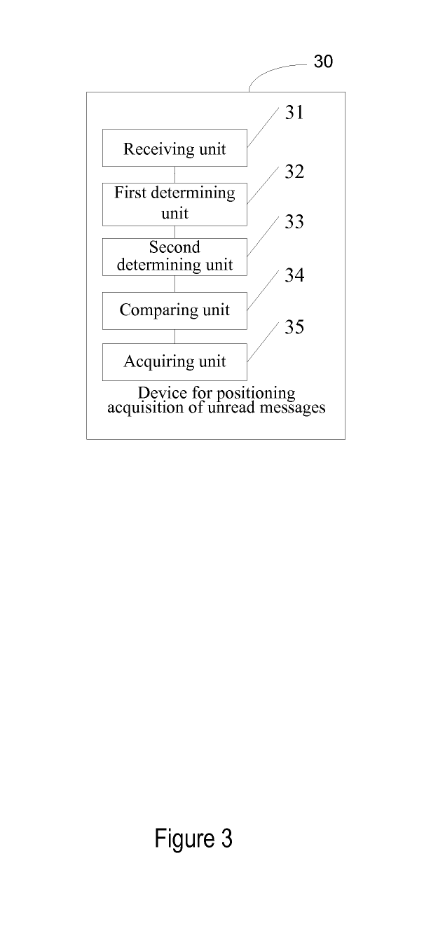

FIG. 3 is a block diagram of an example device for acquiring unread messages provided in the embodiments of the present disclosure, which device, as shown in FIG. 3, comprises a receiving unit 31, a first determining unit 32, a second determining unit 33, a comparing unit 34 and an acquiring unit 35, wherein:

The receiving unit 31 is configured to receive a command for acquiring unread messages.

The receiving unit 31 may receive an operation command that is received by clicking a button for acquiring unread messages on the device for acquiring of unread messages by a user, e.g. by clicking or double-clicking this button. Wherein, the device may be a PC, a tablet computer, a mobile phone, a smart phone, a notebook computer or other equipment. Wherein, the aforementioned unread messages may be unread messages of a first communication account, and this step may be that a receiving user clicks a button for acquiring unread messages on a user interface of the first communication account. Wherein, the aforementioned interface may be preset by a communication platform, and sent by the communication platform to the device. Wherein, the communication platform may be a server, that is, the terminal logs on the communication platform using the first account, and receives the operation command that is input by the user at the logon interface sent by the communication platform.

The first determining unit 32 is configured to determine the priority values of the unread messages.

The priority values are configured to indicate the priority levels of the unread messages, e.g. reception time of the unread messages or friend levels of sending communication accounts of the unread messages and the first communication account, for example: the first determining unit 32 may also be configured to calculate the priority values of the unread messages according to the reception time of the unread messages of the first communication account. That is, the priority values of the unread messages are in proportion to the reception time of the unread messages, e.g., earlier reception time of an unread message means higher priority value of this unread message, otherwise, later reception time means lower priority value.

For example, the first determining unit 32 may also be configured to calculate the priority values of sending communication accounts according to the friend levels of the sending communication accounts of the unread messages of the first communication account and the first communication account, and use the priority values of the sending communication accounts as the priority values of the unread messages corresponding to the sending communication accounts; wherein, the sending communication accounts of the unread messages are communication accounts that are used by a terminal sending the unread messages to send the unsent messages. That is, the priority values of the unread messages are in proportion to the friend levels of the sending communication accounts of the unread messages and the first communication account, e.g. higher friend level of the sending communication account of an unread message and the first communication account means higher priority value of this unread message, otherwise, lower friend level means lower priority value.

The second determining unit 33 is configured to determine a threshold value to position acquired unread messages. After the threshold value is determined, the priority values of the unread messages can be compared with the threshold value to acquire the unread messages. The second determining unit 33 may also be configured to preset a threshold value, that is, preset a fixed value; for example, only the unread message with the highest priority value is displayed. Only the unread message with the highest priority value is acquired by the acquiring unit 35. By way of example and without limitation, only the unread messages with priority values which rank at the top three in a descending order are acquired, in one scenario.

In another embodiment, the second determining unit 33 may also be configured to set a threshold value according to the number of unread messages of a first communication account, wherein the threshold value is in direct proportion to the number of unread messages of the first communication account. For example, the more the unread messages of the first communication account are, the larger the threshold value is set, otherwise, the smaller the threshold value is set. That is, the threshold value is calculated in real-time, and varies with the number of unread messages of the first communication account, for example, the threshold value may be set as 10 if the number of unread messages of the first communication account is 100, and may be set as 4 if the number of unread messages of the first communication account is 20.

The comparing unit 34 is configured to compare the priority values with the threshold value.

This comparison may be a value comparison, in order to subsequently acquire the unread messages.

The acquiring unit 35 is configured to acquire the unread message if the priority value of the unread message is larger than the threshold value.

In this step, the unread messages the priority values of which are larger than the threshold value can be acquired, thus the unread messages the priority values of which are larger than the threshold value can be acquired from a plurality of unread messages, that is, these acquired unread messages may be required most by a user.

In the aforementioned technical solution, a command for acquiring unread messages is received; the priority values of the unread messages are determined; a threshold value configured to position acquirable unread messages is determined; the priority values are compared with the threshold value; and the unread message is acquired if the priority value of the unread message is larger than the threshold value, in this way, the unread messages can be acquired rapidly only by reception of the command for acquiring unread messages.

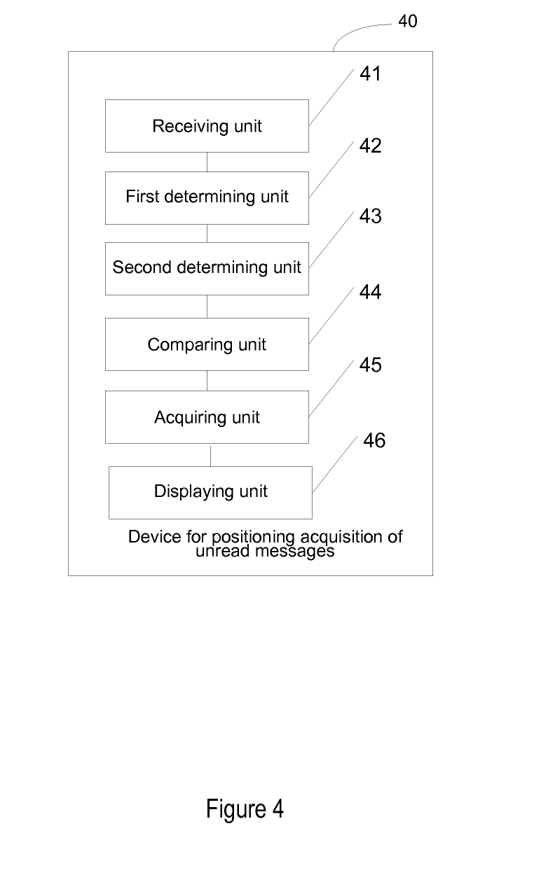

FIG. 4 is a structural diagram of another device for acquiring of unread messages provided in the embodiments of the present disclosure, which device, as shown in FIG. 4, comprises a receiving unit 41, a first determining unit 42, a second determining unit 43, a comparing unit 44, an acquiring unit 45 and a display unit 46, wherein:

The receiving unit 41 is configured to receive a command for acquiring unread messages.

The receiving unit 41 may receive an operation command that is received by clicking a button for acquiring unread messages on the device by a user, e.g. by clicking or double-clicking this button. Wherein, the device may be a PC, a tablet computer, a mobile phone, a smart phone, a notebook computer or other equipment. Wherein, the aforementioned unread messages may be unread messages of a first communication account, and this step may be that a receiving user clicks a button for acquiring unread messages on a user interface of the first communication account. Wherein, the aforementioned interface may be preset by a communication platform, and sent by the communication platform to the device. Wherein, the communication platform may be a server, that is, the terminal logs on the communication platform using the first account, and receives the operation command that is input by the user at the logon interface sent by the communication platform.

The first determining unit 42 is configured to determine the priority values of the unread messages.

The priority values in this step are configured to indicate the priority levels of the unread messages, e.g. reception time of the unread messages or friend levels of sending communication accounts of the unread messages and the first communication account, for example: the first determining unit 42 may also be configured to calculate the priority values of the unread messages according to the reception time of the unread messages of the first communication account. That is, the priority values of the unread messages are in proportion to the reception time of the unread messages, e.g., earlier reception time of an unread message means higher priority value of this unread message, otherwise, later reception time means lower priority value.

The first determining unit 42 may also be configured to calculate the priority values of sending communication accounts according to the friend levels of the sending communication accounts of the unread messages of the first communication account and the first communication account, and use the priority values of the sending communication accounts as the priority values of the unread messages corresponding to the sending communication accounts; wherein, the sending communication accounts of the unread messages are communication accounts that are used by a terminal sending the unread messages to send the unsent messages. The priority values may be calculated using any one of the previously discussed methods, for example friend level, reception time etc.

The second determining unit 43 is configured to determine a threshold value configured to position acquirable unread messages.

The comparing unit 44 is configured to compare the priority values with the threshold value.

The acquiring unit 45 is configured to acquire the unread message if the priority value of the unread message is larger than the threshold value.

The displaying unit 46 is configured to display the acquired unread messages.

In another embodiment, the unread messages may also be displayed in a multilevel way, for example: if the display area required for displaying the acquired unread messages is larger than the area of the interface configured to display the unread messages, the acquired unread messages may also be displayed in a multilevel way, or acquired in a multilevel way. That is, if the display area for displaying the unread messages acquired by the acquiring unit 45 is larger than the area of the interface configured to display the unread messages, the unread messages acquired by the acquiring unit 45 cannot be displayed at a time. In this embodiment, the aforementioned threshold value may comprise a first threshold value and a second threshold value. The second determining unit may further include a first determining subunit (not shown in the drawings), may be configured to determine first priority values of the unread messages.

A second determining subunit (not shown in the drawings), may be configured to determine second priority values of the unread messages. That is, each of the unread messages are associated with two priority values, i.e. the first priority value and the second priority value, and these two priority values are compared with the first threshold value and the second threshold value, respectively. The acquiring unit 45 may be configured to acquire a first set of unread messages with priority values that exceed the first threshold. If the displaying area for displaying the first set of unread messages is larger than the area of the interface configured to display the unread messages, the acquiring unit 45 may also be configured to acquire, from the first subset of unread message, a second set of unread messages with second priority values which are larger than the second threshold value. In this way, the display area for displaying the acquired second unread messages can be smaller than the area of the interface configured to display the unread messages. That is, the displaying unit 46 can display the aforementioned second unread messages.

In the aforementioned technical solution, a plurality of alternative embodiments are described on the basis of the embodiments hereinabove, and the unread messages can be displayed rapidly according to the priority values of the unread messages.

It can be understood by those ordinary skilled in this art that, implementation of all of or a part of the flow in the method of the aforementioned embodiments may be accomplished by commanding relevant hardware through computer programs, which may be stored in a computer-readable storage medium, and when these programs are executed, the flow in the aforementioned embodiments of the method may be included therein. Wherein, the storage medium may be Disk, Compact Disk, Read-Only Memory (ROM for short) or Random Access Memory (RAM for short), etc.

Each of the methods described herein may be encoded in a computer-readable storage medium (e.g., a computer memory), programmed within a device (e.g., one or more circuits or processors), or may be processed by a controller or a computer. If the processes are performed by software, the software may reside in a local or distributed memory resident to or interfaced to a storage device, a communication interface, or non-volatile or volatile memory in communication with a transmitter. The memory may include an ordered listing of executable instructions for implementing logic. Logic or any system element described may be implemented through optic circuitry, digital circuitry, through source code, through analog circuitry, or through an analog source, such as through an electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable storage medium,” “machine-readable medium,” “propagated-signal” medium, and/or “signal-bearing medium” may comprise a medium (e.g., a non-transitory medium) that stores, communicates, propagates, or transports software or data for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory, such as a Random Access Memory (RAM), a Read-Only Memory (ROM), an Erasable Programmable Read-Only Memory (EPROM or Flash memory), or an optical fiber. A machine-readable medium may also include a tangible medium, as the software may be electronically stored as an image or in another format (e.g., through an optical scan), then compiled, and/or interpreted or otherwise processed. The processed medium may then be stored in a computer and/or machine memory.

While various embodiments, features, and benefits of the present system have been described, it will be apparent to those of ordinary skill in the art that many more embodiments, features, and benefits are possible within the scope of the disclosure. For example, other alternate systems may include any combinations of structure and functions described above or shown in the figures.

1. A method for acquiring unread messages, comprising:
in response to a command for acquiring unread messages, determining a respective priority value for each of the unread messages, wherein the unread messages are associated with a receiving communication account and wherein each unread message is associated with a sending communication account;
acquiring an unread message if the respective priority value of the unread message is larger than a threshold value.

2. The method of claim 1 wherein the command for acquiring the unread messages is input by a user.

3. The method of claim 1 further comprising determining the threshold value, wherein determining the threshold value comprises:
presetting the threshold value; or
determining the threshold value based on the number of unread messages of the first communication account, wherein the threshold value is in direct proportion to a number of unread messages.

4. The method of claim 3, wherein determining the respective priority value of the unread message comprises:
calculating the respective priority value of the unread messages according to a respective reception time of the unread messages.

5. The method of claim 3 wherein, the respective priority value of the unread message is determined based on the sending communication account associated with the unread message.

6. The method of claim 5 further comprising determining a friend level for the sending communication account wherein the friend level is determined based on prior communication between the sending communication account and the receiving communication account.

7. The method of claim 5 further comprising determining a friend level for the sending communication account wherein the friend level is determined based on a number of read messages between the sending communication account and the receiving communication account; or
a number of unread messages between the sending communication account and the receiving communication account; or
a number of the read messages and a number of unread messages between the sending communication account and the receiving account.

8. A method implemented at a server, the method for acquiring unread messages, wherein each unread message is associated with a sending communication account, the method comprising:
selecting a first subset of the unread messages based on a respective first priority value associated with each of the unread messages, wherein the respective first priority of the selected first subset of the unread messages exceeds a first threshold;
selecting a second subset based on a respective second priority value associated with each of the unread messages, wherein the respective second priority value of the selected second subset of the unread messages exceeds a second threshold, wherein the second subset is selected from the first subset of unread messages; and
acquiring the second subset of the unread messages.

9. The method of claim 8 further comprising determining the respective first priority value wherein determining the respective first priority value comprises:
calculating the respective first priority value of an unread message based on the reception time of the unread message or
calculating the respective first priority value of an unread message according to the friend level of the sending communication account and the receiving communication account.

10. The method of claim 8 further comprises determining the respective second priority value wherein determining the respective second priority value comprises:
calculating the respective second priority value of an unread message based on the reception time of the unread message or
calculating the respective second priority value of an unread message according to the friend level of the sending communication account and the receiving communication account.

11. A device for acquiring unread messages, comprising: a receiving unit, a first determining unit, a second determining unit, a comparing unit and an acquiring unit, wherein:
the receiving unit is configured to receive a command for acquiring unread messages;
the first determining unit is configured to determine the priority values of the unread messages;
the second determining unit is configured to determine a threshold value configured to position acquirable unread messages;
the comparing unit is configured to compare the priority values with the threshold value; and
the acquiring unit is configured to acquire the unread message if the priority value of the unread message is larger than the threshold value.

12. The device as claimed in claim 11, further comprising:
a displaying unit, configured to display the acquired unread messages;
and the operation command for acquiring the unread messages is input by a user.

13. The device as claimed in claim 11, wherein the second determining unit is further configured to preset a threshold value; or
the second determining unit is configured to set a threshold value according to the number of unread messages of a first communication account, wherein the threshold value is in direct proportion to the number of unread messages of the first communication account.

14. The device as claimed in claim 11, wherein the first determining unit is further configured to calculate the priority values of the unread messages according to the reception time of the unread messages of the first communication account.

15. The device as claimed in claim 11, wherein the first determining unit is further configured to calculate the priority values of sending communication accounts according to the friend levels of the sending communication accounts of the unread messages of the first communication account and the first communication account, and use the priority values of the sending communication accounts as the priority values of the unread messages corresponding to the sending communication accounts; wherein, the sending communication accounts of the unread messages are communication accounts that are used by a terminal sending the unread messages to send the unsent messages, and the first communication account is a communication account corresponding to the unread messages.

16. The device as claimed in claim 15, wherein the friend levels of the sending communication accounts and the first communication account comprises:
friend levels of the sending communication accounts and the first communication account sent by a receiving communication platform; or
friend levels of the sending communication accounts and the first communication account calculated according to communication records between the sending communication accounts and the first communication account.

17. The device as claimed in claim 15, wherein the friend levels of the sending communication accounts and the first communication account calculated according to the communication records between the sending communication accounts and the first communication account comprises:
friend levels of the sending communication accounts and the first communication account calculated according to communication records of the read messages between the sending communication accounts and the first communication account; or
friend levels of the sending communication accounts and the first communication account calculated according to communication records of the unread messages between the sending communication accounts and the first communication account; or
friend levels of the sending communication accounts and the first communication account calculated according to communication records of the read and unread messages between the sending communication accounts and the first communication account.

18. The device as claimed in claim 11, wherein the threshold value comprises: a first threshold value and a second threshold value;
the second determining unit comprises:
a first determining subunit, configured to determine first priority values of the unread messages;
a second determining subunit, configured to determine second priority values of the unread messages;
the acquiring unit is further configured to acquire, in the unread messages, first unread messages the first priority values of which are larger than the first threshold value; and to acquire, in the first unread messages, second unread messages the second priority values of which are larger than the second threshold value.

19. The device as claimed in claim 18, wherein the first determining subunit is further configured to calculate the priority values of the unread messages according to the reception time of the unread messages of the first communication account;
the second determining subunit is further configured to calculate the priority values of sending communication accounts according to the friend levels of the sending communication accounts of the unread messages of the first communication account and the first communication account, and use the priority values of the sending communication accounts as the priority values of the unread messages corresponding to the sending communication accounts.

20. The device as claimed in claim 18, wherein the first determining subunit is further configured to calculate the priority values of sending communication accounts according to the friend levels of the sending communication accounts of the unread messages of the first communication account and the first communication account, and use the priority values of the sending communication accounts as the priority values of the unread messages corresponding to the sending communication accounts;
the second determining subunit is further configured to calculate the priority values of the unread messages according to the reception time of the unread messages of the first communication account.
